(19) United States
(12) Patent Application Publication
(10) Pub. No.: US 2017/0322787 A1
(43) Pub. Date: Nov. 9, 2017

(54) PROVIDING ENTERPRISE PRODUCT BUNDLES AS A CLOUD-BASED SERVICE

(71) Applicant: ADOBE SYSTEMS INCORPORATED, SAN JOSE, CA (US)

(72) Inventors: MANSUKH PATIDAR, Greater Noida (IN); Saransh Katariya, Indore (IN); Aditya Falodiya, Cupertino, CA (US)

(21) Appl. No.: 14/725,937

(22) Filed: May 29, 2015

(51) Int. Cl. G06F 9/445

(52) U.S. Cl. CPC G06F 8/60

(57) ABSTRACT

Systems, methods, and computer-readable storage media are provided for creating and delivering product packaging as a cloud-based service to enterprise administrators. Administrators utilize user credentials to access a web-based portal where a name or identifier of each package created by any enterprise administrator of the organization is presented. Some pre-created packages also may be presented. Utilizing the web-based portal, administrators may create new product packages or update existing product packages. Selected, created, and/or updated product packages are customized based on the user credentials of the accessing/creating administrator. Customized packages are stored in association with a cloud computing infrastructure. When an enterprise administrator wants to deploy a customized product package, the package is downloaded to the administrator's machine from which it may be deployed.

### BACKGROUND

Enterprises often have a dedicated Information Technology (IT) team which manages the hardware and software inside their organization. These teams generally have administrative rights to install any software on the machines inside their organizations. Many enterprises (e.g., government organizations, businesses, banks, schools, and the like) operate in restricted environments where only a dedicated IT team member has rights to install software on a system and employees are not given administrative rights over their machines. In such enterprises, any change in machine configuration is IT controlled.

An enterprise administrator is a member of an IT team that has administrative rights and whose responsibility it is to install and maintain the software resources of an organization. Often, a primary task for such administrators is to install software on the organization's client machines remotely and silently. Various remote deployment tools like System Center Configuration Manager (SCCM), Apple Remote Desktop (ARD), etc. are available for this purpose. To simplify the deployment process, enterprise administrators often create packages of products and updates they want to deploy on the organizations' client machines so that they can deploy all relevant products and updates via a single installation procedure. While efficient on an administrator-by-administrator basis, various enterprise administrators employed by an organization and operating, for instance, in different geographies and/or time zones, often end up making these packages on their individual systems and managing them independently. This leads to poor management of packages created by various administrators as duplicate and redundant packages are often generated. Having multiple administrators responsible for product installation also can lead to poor management of licenses purchased by the enterprise as one administrator may not be aware of the number of installations that have been performed by another administrator of the same organization.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention provide systems and methods for delivering packaged products as a cloud-based service to enterprise administrators. In some implementations, administrators utilize user credentials to log into a web-based portal where identifiers for the packages created by any administrator of the enterprise are presented in a user interface. Identifiers for generic packages pre-created, for instance, by software providers, also may be presented. Each identifier generally includes a name or title that is descriptive of the product(s) that are included in the respective package to make the package and its contents readily identifiable and understood by enterprise administrators using the user interface. Alternatively, a package name or identifier may be selectable (e.g., via a hover or click action associated with the identifier) to reveal information about the products that are bundled together in its corresponding package. Utilizing the web-based portal, administrators further may generate and name new product packages or update existing product packages, in some instances naming the updated packages to reflect the changes made.

Product packages that are generated, and/or updated by an administrator are customized based on the user credentials of the accessing, creating, and/or updating administrator. The user credentials may include, for instance, license information, entitlement information, permissions information, and user preferences (e.g., operating system preferences). Once created, customized packages are stored in association with a cloud computing infrastructure. When an enterprise administrator desires to deploy a customized product package to one or more client machines in their enterprise, the customized product package is downloaded to the administrator's client machine for deployment. In this way, each package generated, updated, or customized by an enterprise administrator may be visible and accessible to all other administrators in the organization.

Thus, in accordance with aspects of the present disclosure, product packages for an organization can be centrally managed. In doing so, inefficiencies in the creation, updating, and management of product packages can be reduced. An enterprise administrator can create a product package on any computer that can access the web-based portal and another administrator of the same organization can reuse the product package by simply downloading it from the cloud, optionally after customizing the package.

### BRIEF DESCRIPTION OF THE DRAWINGS

Certain embodiments of the present invention are illustrated by way of example and not limitation in the accompanying figures in which like reference numerals indicate similar elements and in which:

FIG. 1 is a block diagram of an exemplary computing system in which embodiments of the invention may be employed;

FIG. 2 is a flow diagram showing an exemplary method for creating product packages as a cloud-based service, in accordance with embodiments of the present invention;

FIGS. 3-5 are exemplary screen displays illustrating features of creating product packages as a cloud-based service, in accordance with embodiments of the present invention;

FIG. 6 is a flow diagram showing an exemplary method for providing product packages as a cloud-based service, each in accordance with an embodiment of the present invention;

FIGS. 7 and 8 are exemplary screen displays illustrating features of providing product packages as a cloud-based service, in accordance with embodiments of the present invention; and

FIG. 9 is a block diagram of an exemplary computing environment suitable for use in implementing embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising.” In addition, words such as “a” and “an,” unless otherwise indicated to the contrary, include the plural as well as the singular. Thus, for example, the requirement of “a feature” is satisfied when one or more features are present. Also, the term “or” includes the conjunctive, the disjunctive and both (a or b thus includes either a or b, as well as a and b).

As previously set forth, an enterprise administrator is an individual having administrative rights and the responsibility to install and maintain the software resources of an organization. Often, a primary task for such administrators is to install software on the organization's client machines remotely and with minimal disruption to the organization's end users. Various remote deployment tools like System Center Configuration Manager (SCCM), Apple Remote Desktop (ARD), etc. are available for this purpose.

To make the deployment process easier, enterprise administrators often generate packages of products and updates they want to deploy on the organizations' client machines so that they can deploy all relevant products and updates via a single installation procedure. Various desktop tools are used to create packages of products and updates. Various enterprise administrators working for an organization and operating, for instance, in different geographies and/or time zones, often end up making these packages on their individual systems and managing them independently. This can lead to poor management of packages created by various administrators as duplicate and redundant packages are often generated. This can further lead to poor management of licenses purchased by the enterprise as one administrator may not be aware of the number of installations that have been performed by another administrator of the same organization.

Aspects of the present invention provide for the creation, updating, management, and deployment of product packages as a cloud-based service for the enterprise administrators within a particular organization. Using the cloud-based service, the efforts of individual enterprise administrators can become known and available to other administrators throughout the organization, thereby reducing inefficiencies in the creation and management of product packages.

A “product package,” as utilized herein, refers to a plurality of software products that are bundled together so as to be capable of deployment via a single installation procedure. Product packages may be pre-created (for instance, by a software developer) or created by enterprise administrators and stored in association with a cloud computing infrastructure. Once created, product packages can be customized based upon administrator credentials and downloaded from the cloud-based infrastructure for deployment. Aspects hereof permit simplification of the process of creating and modifying software product packages and, at the same time, permit multiple administrators in an organization to be in sync with the latest packages.

In various embodiments, systems and methods are provided for creating product packages as a cloud-based service. Utilizing user credentials assigned by the enterprise and stored in association with a data store accessible by the system hereof, an enterprise administrator accesses a comprehensive web-based product package portal. Upon accessing the portal, a user interface is presented that includes a listing of identifiers for product packages associated with the enterprise. An identifier generally includes a name or title that is descriptive of the products that are included in a respective package to make the package and its contents readily identifiable and understood by the accessing enterprise administrator. Alternatively, a package name or identifier may be selectable (e.g., via a hover action, a click action, or the like associated with the identifier) to reveal information about the products that are bundled together in the package. In some cases, a search capability may be provided for narrowing lengthy listings of available product packages.

In certain respects, the user interface includes a selectable button or link for creating a product package. Upon user selection of the selectable button or link, a user interface is presented that permits the enterprise administrator to provide details pertaining to the package he or she wishes to create. Such details may include, by way of example only, a package name, an operating system, an organization name or identifier, processing power availability, and the like. Some details (for instance, organization names or identifiers, operating system preferences, and the like) may be presented in appropriate user interface fields as default options associated with the user credentials for expedited selection of those details. These details may rarely change from package to package for a given enterprise administrator.

In addition to package details, an enterprise administrator is also afforded an opportunity to select each product for which inclusion in the package is desired. Once all package details and product selections are input by the enterprise administrator, the product package is built in accordance therewith and may be downloaded to the enterprise administrator's client machine.

Once built, an identifier of the package can be included in any listing of product packages where it is available for access by other administrators of the enterprise. In aspects, if selected for download by a different enterprise administrator than the creator of the package, portions of the package creation process may be presented to the other enterprise administrator with prepopulated selections based on, for instance, the other enterprise administrator's preferred default selections (associated with the other enterprise administrator's user credentials), available licenses (which, in aspects hereof, may be tracked by the system of present invention and may result in changes to the products included in a subsequently downloaded product package due to insufficient license availability), administrator-specific permissions, and the like. This can significantly reduce the time it would take for the other enterprise administrator to create a product package where modifications to the original package are primarily based upon associated user credentials.

In further respects, systems, methods, and computer storage media also are provided for delivering product packages as a cloud-based service. Utilizing user credentials assigned by the enterprise, an enterprise administrator accesses a comprehensive web-based product package portal. Upon accessing the portal, a user interface is presented that includes a listing of identifiers for all packages associated with the enterprise that are available for installation. An identifier generally includes a name or title that is descriptive of the products that are included in the package to make the package and its contents readily identifiable and understood by the accessing enterprise administrator. Alternatively, a package name or identifier may be selectable to reveal information about the products that are bundled together in the package and/or a product package search capability may be provided.

In aspects hereof, the enterprise administrator selects an identifier associated with a particular product package for downloading to his or her client machine. Utilizing the administrator's user credentials, the selected product is customized for the enterprise administrator and a customized product package is built. Generally, the customized product package includes all of the products that were bundled together in the selected product package. However, in some instances (for instance, when a particular product of the bundle does not include any more licensed installations and/or when the enterprise administrator does not have appropriate permissions to download a product included in the product package), fewer than all of the products included in the selected product package will be included in the customized product package. Once built, the customized product package is downloaded to the enterprise administrator's client machine from which the enterprise administrator may install the customized product package on other machines of the enterprise. Once the customized product package is created, an identifier is included in the listing of product packages available for installation, generally with an indication of the enterprise administrator's identity to indicate for whom the product package has been customized and to differentiate it from a non-customized version of the product package.

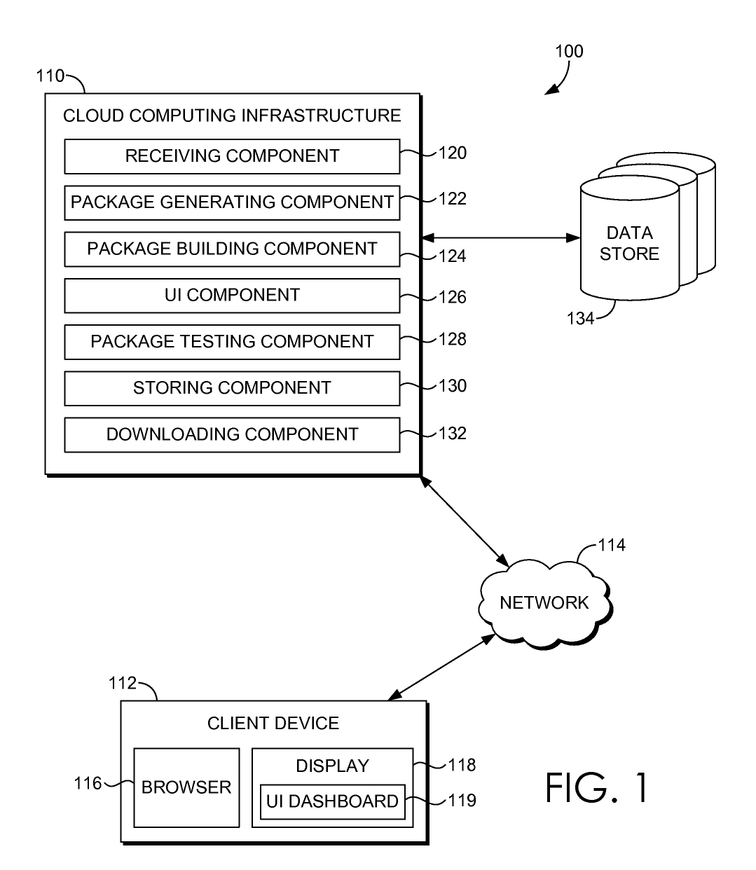

Referring now to FIG. 1, a block diagram is provided illustrating an exemplary computing system 100 in which certain embodiments of the present invention may be employed. Generally, the computing system 100 illustrates an environment in which product packaging may be delivered as a cloud-based service to enterprise administrators. Among other components not shown, the computing system 100 generally includes a cloud computing infrastructure 110 and a client device 112 in communication with one another via a network 114. The network 114 may include, without limitation, one or more local area networks (LANs) and/or wide area networks (WANs). Such networking environments are commonplace in offices, enterprise-wide computer networks, intranets and the Internet. Accordingly, the network 114 is not further described herein.

It should be understood that any number of cloud computing infrastructures and/or client devices may be employed in the computing system 100 within the scope of embodiments of the present invention. Each may comprise a single device/interface or multiple devices/interfaces cooperating in a distributed environment. For instance, the cloud computing infrastructure 110 may comprise multiple devices and/or modules arranged in a distributed environment that collectively provide the functionality of the cloud computing infrastructure 110 described herein. Additionally, other components or modules not shown also may be included within the computing system 100.

In some aspects, one or more of the illustrated components/modules may be implemented as stand-alone applications. In other aspects, one or more of the illustrated components/modules may be implemented via the cloud computing infrastructure 110, the client device 112, or as an Internet-based service. It will be understood by those of ordinary skill in the art that the components/modules illustrated in FIG. 1 are exemplary in nature and in number and should not be construed as limiting. Any number of components/modules may be employed to achieve the desired functionality within the scope of embodiments hereof. Further, components/modules may be located in association with any number of cloud computing infrastructures or client devices. By way of example only, the cloud computing infrastructure 110 might be provided as a single computing device (as shown), a cluster of computing devices, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

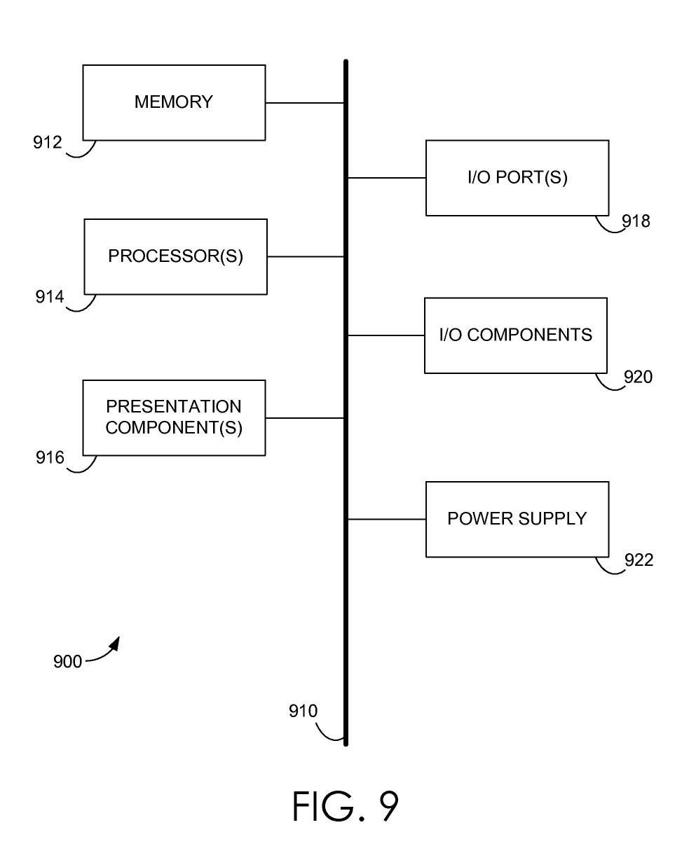

The client device 112 may include any type of computing device, such as the computing device 900 described more fully below with reference to FIG. 9, for example. Generally, the client device 112 includes a browser 116 and a display 118. The browser 116, among other things, is configured to render a user interface (UI) associated with a web portal, possibly in the form of a UI dashboard 119, in association with the display 118 of the client device 112. The browser 116 further is configured to receive (generally via an I/O component, such as a stylus or keypad, and/or via a UI presented on the display 118 and permitting alpha-numeric and/or textual input) user selection of various product package identifiers and/or user requests to create customized product packages. The browser 116 additionally is configured to receive content for presentation on the display 118, for instance, from the cloud computing infrastructure 110. It should be noted that the functionality described herein as being performed by the browser 116 may be performed by any other application, application software, user interface, or the like capable of rendering Web content. It should further be noted that embodiments of the present invention are equally applicable to mobile computing devices and devices accepting gesture, touch and/or voice input. Any and all such variations, and any combination thereof, are contemplated to be within the scope of embodiments of the present invention.

The cloud computing infrastructure 110 is configured to permit access (for instance, by enterprise administrators) to pre-configured product packages (that is, product packages that have been provided by software providers) and product packages that have been customized by the accessing user, or that have been customized by any other enterprise administrator in their organization. The cloud computing infrastructure 110 additionally is configured to permit creation of customized product packages. The cloud computing infrastructure 110 further is configured to initiate download of product packages for remote deployment by enterprise administrators.

In this regard, the cloud computing infrastructure 110 has access to a data store 134 configured to store information pertaining to product packages, product updates, user credentials (e.g., licenses, permissions, entitlements, preferences, etc.), and the like. In embodiments, the data store 134 is configured to be searchable for one or more of the items stored in association therewith. It will be understood and appreciated by those of ordinary skill in the art that the information stored in association with the data store 134 may be configurable and may include any information relevant to, by way of example only, products, product packages, product licenses, user preferences, user entitlements, user permissions, other user credentials, and the like. The content and volume of such information are not intended to limit the scope of embodiments of the present invention in any way. Further, the data store 134 may be a single, independent component or a plurality of storage devices, for instance, a database cluster (as shown), portions of which may reside in association with the cloud computing infrastructure 110, the client device 112, another external computing device (not shown), and/or any combination thereof.

As illustrated, the cloud computing infrastructure 110 includes a receiving component 120, a package generating component 122, a package building component 124, a UI component 126, a package testing component 128, a storing component 130, and a downloading component 132.

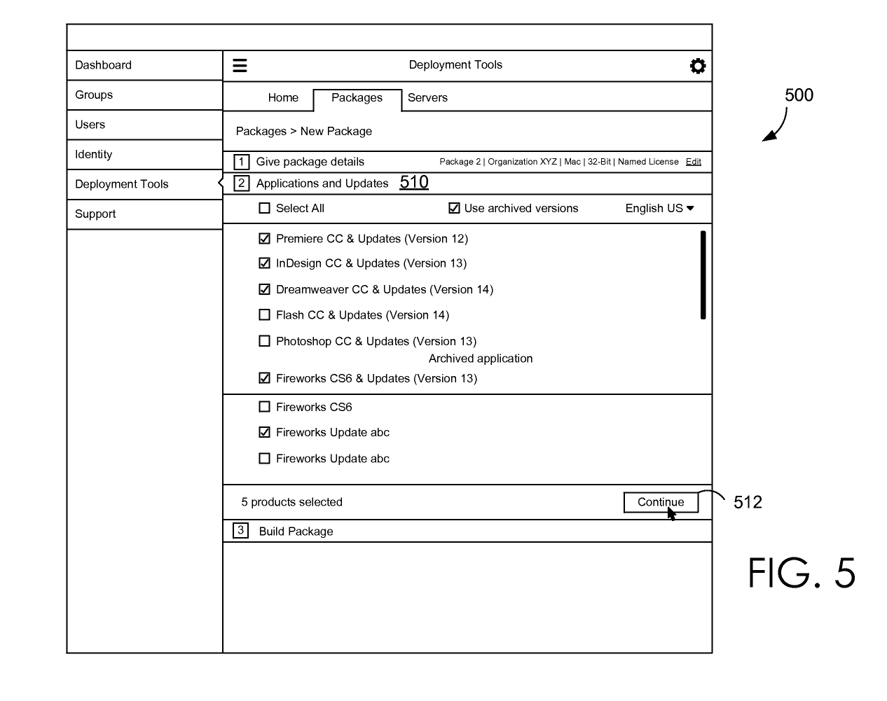

As previously set forth, enterprise administrators often create packages of products and updates they want to deploy on an organizations' client machines so that they can deploy all relevant products and updates via a single installation procedure, often remotely. In this regard, the receiving component 120 is configured to receive, from a web portal, requests to bundle or package a plurality of identified products into a product package. An exemplary user interface permitting identification of products for bundling into a product package is illustrated and more fully described below with reference to FIG. 5. The receiving component 120 additionally is configured for receiving selections of generic product package identifiers, the generic product packages associated with the identifiers being pre-configured, for instance, by software product manufactures and/or distributors and including, in certain aspects, products most commonly bundled together across multiple enterprises. Still further, the receiving component 120 is configured to receive a selection of an access location identifier, for instance a Uniform Resource Locator (URL), selection of which causes the web portal to navigate to the location from which the product package associated with the access location identifier may be downloaded.

The package generating component 122 is configured for collecting information for generating custom product packages. Such information may include information about a plurality of products for which a request to bundle into a product package has been received, for instance, product version and/or update information. Such information also may include information about a plurality of products that comprises a generic product package identified by a selected product package identifier. In certain aspects hereof, the collected information further may include user credentials associated with a user who has requested bundling of products or selected a pre-configured product bundle for deployment. Such user credentials may include, by way of example only, license information, entitlement information, permissions information, user preferences (e.g., operating system preferences), and the like.

The package building component 124 is configured for generating custom product packages. Custom product packages are product packages that include at least one product as part of the package that has been tailored in accordance with one or more customizations associated with the user credentials of an accessing or requesting user. Such customizations may relate to, by way of example only, product licenses, entitlements, permissions, and/or user preferences (e.g., operating system preferences). It will be understood by those having ordinary skill in the art that not all custom product packages necessarily include product modifications. Rather, a product package may be considered “custom” simply by being analyzed against the appropriate user credentials, even if such analysis yields the result that no product package modifications are required.

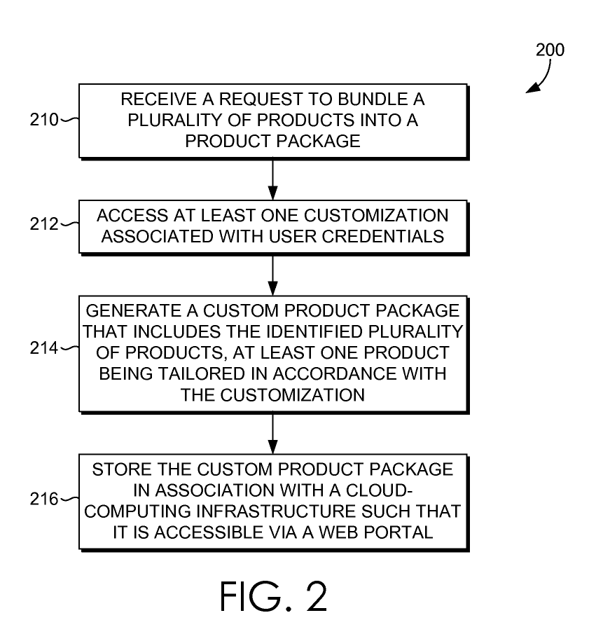

The UI component 126 is configured for assigning access location identifiers to custom product packages. The UI component 126 is further configured for copying created and/or customized product packages for storage, for instance, in association with the data store 134, such that the packages are accessible via selection of their respective assigned access location identifiers. Still further, the UI component 126 is configured for presenting a status indicator that indicates a status of a custom product package. Exemplary status indicators may indicate, for instance, that a product package identified by a particular package identifier is in the process of being built and/or validated, that a product package identified by a particular package identifier requires one or more updates to be current, or that a product package identified by a package identifier is updated and available for download. The UI component 126 is configured to present all desired information generated in association with created and/or custom product packages in association with a UI, for instance, a UI dashboard, associated with the web portal. Exemplary UI dashboards are illustrated in the screen displays of FIGS. 2, 4, 5, 7 and 8.

The package testing component 128 is configured for performing one or more tests on created and/or customized product packages to validate such packages and ensure that they are built correctly. In accordance with certain aspects hereof, the package testing component 128 performs validation and other appropriate package tests (as known and appreciated by those of ordinary skill in the art) prior to an access location identifier being assigned to the package (e.g., by the UI component 126) to ensure that all packages having an access location identifier are validated, correctly-built packages.

The storing component 130 is configured for storing created and/or custom product packages in association with the cloud computing infrastructure 110, for instance, in association with the data store 134, such that they are accessible to users via the web portal.

The downloading component 132 is configured for initiating download of custom product packages to client devices, e.g., client devices associated with enterprise administrators. As the downloaded product packages include multiple products bundled together, and include customizations particular to the enterprise administrator (e.g., licenses, operating system preferences, and the like), the administrator can deploy the downloaded product packages remotely via a single installation to end user client devices of the organization, as desired.

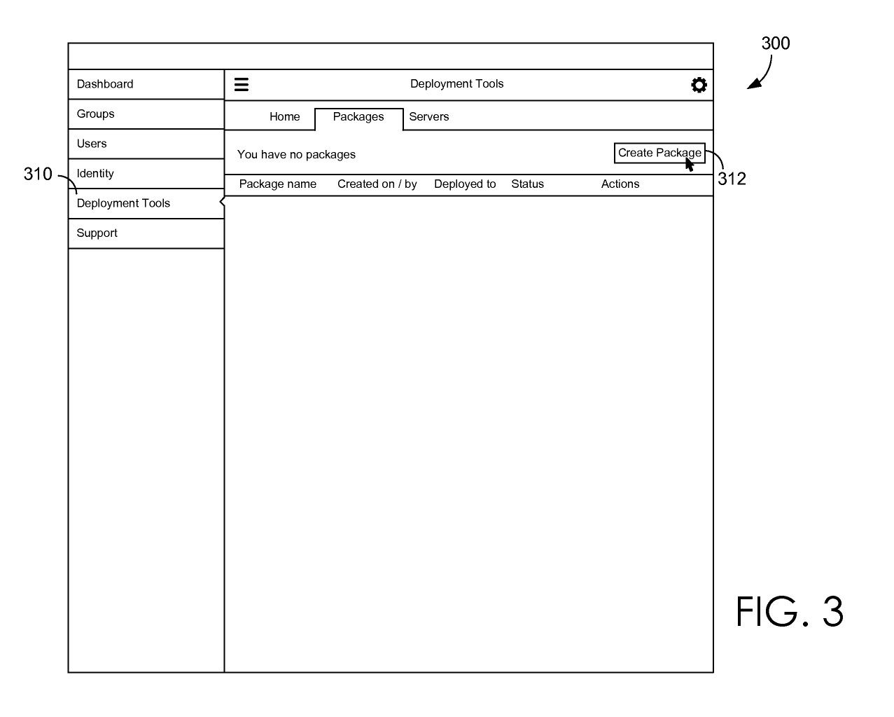

Turning now to FIG. 2, a flow diagram is illustrated showing an exemplary method 200 for creating product packages as a cloud-based service. As indicated at block 210, a request is received (e.g., from a web portal) to bundle an identified plurality of products into a product package. Such request may be received, for instance, by the receiving component 120 of the cloud computing infrastructure 110 of FIG. 1. FIGS. 3-5 illustrate exemplary screen displays showing creation of a product package as a cloud-based service, in accordance with an aspect of the present invention.

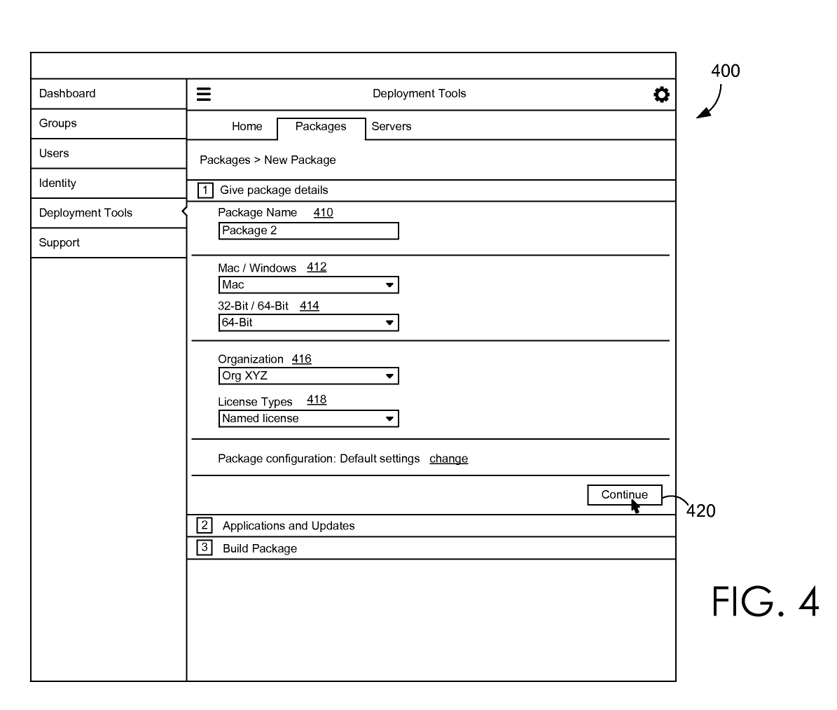

With initial reference to FIG. 3, an exemplary UI dashboard 300 (e.g., UI dashboard 119 of FIG. 1) is illustrated. As illustrated, the exemplary view shows a screen display when the option “Deployment Tools” 310 is selected from the left-hand side of the screen display. From this view, the user may select to create a product package (as a cloud-based service) via selection of the “Create Package” indicator 312. With reference to FIG. 4, an exemplary screen display 400 is illustrated that shows package detail options that may be selected in creating the desired product package. As illustrated, such customizations include package name or identifier 410, operating system 412, processing capability 414, organization identification 416 and license types 418. In aspects, one or more the illustrated customizations may be optional and/or may be prepopulated based upon known preferences of the enterprise administrator. It will be understood and appreciated by those of ordinary skill in the art that any number and variety of customizations may be available and that those illustrated in FIG. 4 are merely exemplary and are not meant to limit embodiments of the present invention in any way.

Selection of the “Continue” indicator 420 causes presentation of the screen display 500 of FIG. 5 where the desired “Applications and Updates” 510 that are desired in creating the product package may be delineated. Selection of the “Continue” indicator 512 causes the desired package to be built in accordance with the details, applications and updates selected.

Returning to FIG. 2, generally, the request received at block 210 is provided by a user (e.g., an enterprise administrator) having associated user credentials. As indicated at block 212, at least one customization associated with the user credentials is accessed. A custom product package that includes one or more of the identified products desired to be packaged is generated (for instance, by the package generating component 122 of the cloud computing infrastructure 110 of FIG. 1), as indicated at block 214. At least one product of the one or more identified products is tailored in accordance with the at least one customization associated with the user credentials. As indicated at block 216, the custom product package is stored (e.g., utilizing the storing component 130 of the cloud computing infrastructure 110 FIG. 1) in association with a cloud-computing infrastructure (e.g., the cloud computing infrastructure 110 of FIG. 1) such that it is accessible via the web portal.

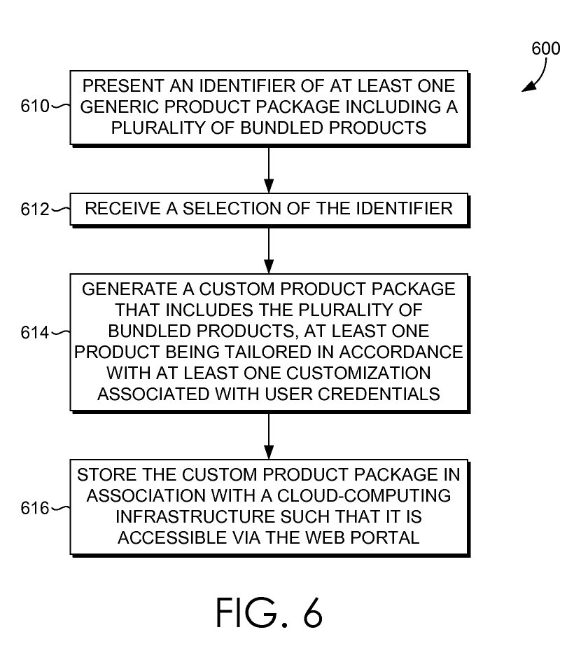

Turning now to FIG. 6, a flow diagram is illustrated showing an exemplary method 600 for providing product packages as a cloud-based service, in accordance with an aspect of the present invention. As indicated at block 610, at a UI associated with a web portal, an identifier of at least one product package is presented. The at least one product package includes a plurality of bundled products and is created, for instance, by the product manufacturer and/or distributer.

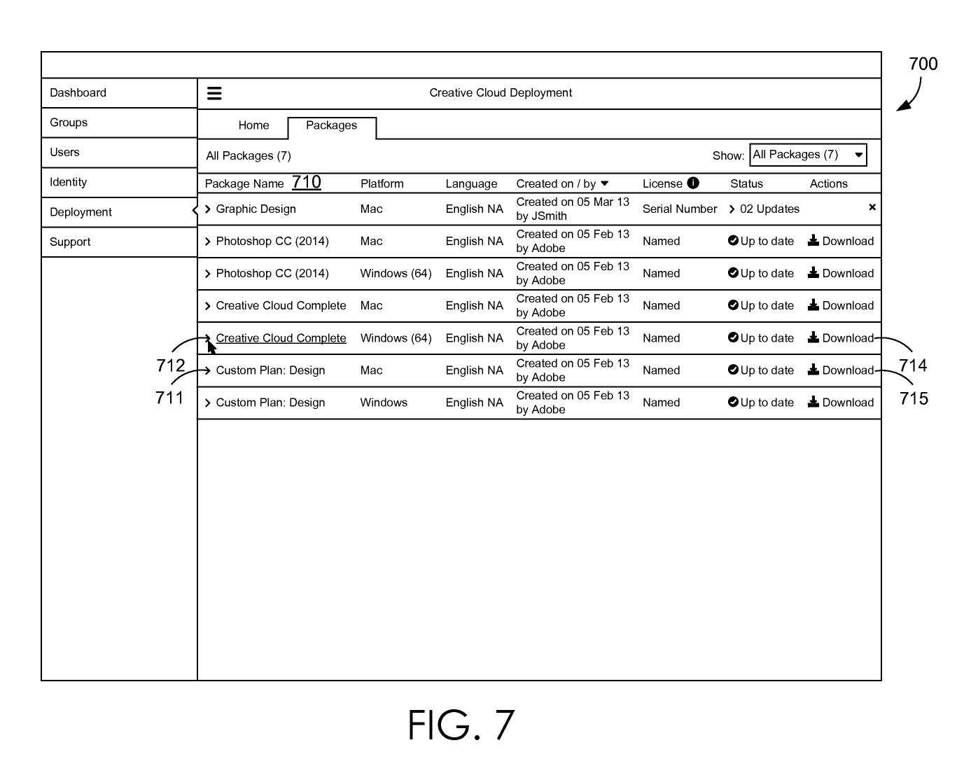

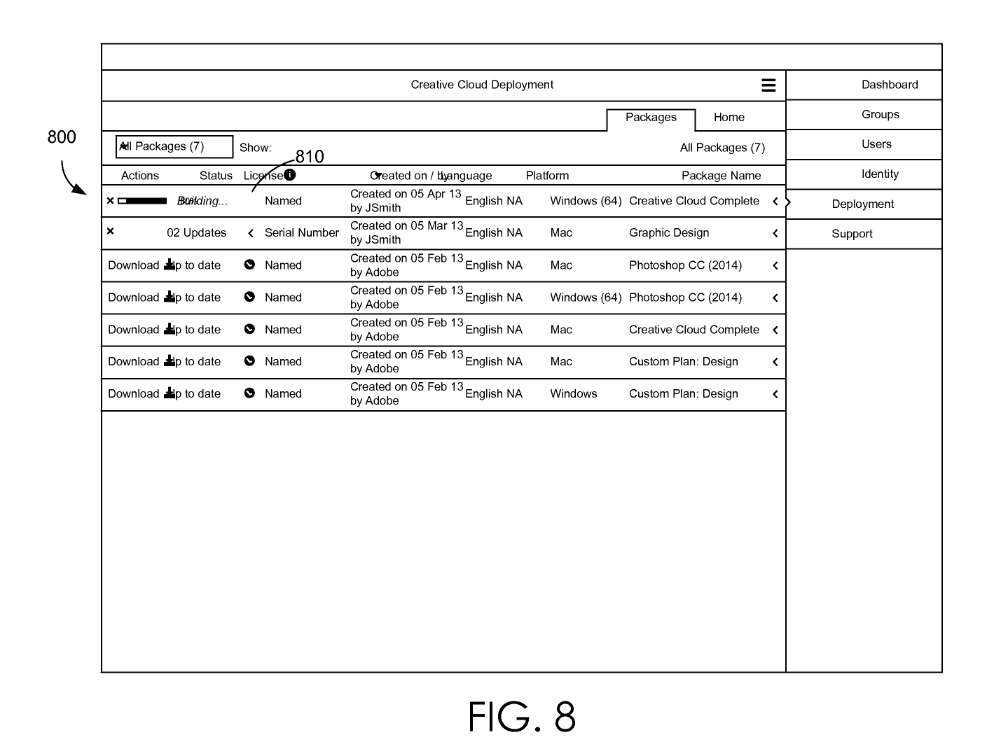

With reference to FIGS. 7 and 8, exemplary screen displays are shown illustrating features of providing product packages as a cloud-based service, in accordance with aspects of the present invention. With initial reference to FIG. 7, the exemplary screen display 700 shows a screen display similar to the UI dashboard shown in FIG. 3, this time with a plurality of already created product packages having selectable package names or identifiers listed under the heading “Package Name” 710. As shown in the exemplary screen display 700, the package name “Creative Cloud Complete” is being selected by the user (as shown by the mouse indicator and identifier underlining in the figure). Upon selection of the “Creative Cloud Complete” indicator 712, the system displays details about the package, such as the applications and/or updates included in the package. Upon selection of the “Download” indicator 714, the generic product package identifier is selected and the system begins building a customized product package, as shown in the screen display 800 of FIG. 8 (“Building . . . ” status indicator 810).

Returning to FIG. 6, a selection of the generic product package identifier by a user is received, as indicated at block 612, the user having one or more associated user credentials. As indicated at block 614, a custom product package is generated that includes at least a portion of the plurality of bundled products (e.g., utilizing package generating component 122 of FIG. 1). At least one product of the portion is tailored in accordance with one or more customizations associated with the associated user credentials. (Note that it is this process that is indicated by the “Building . . . ” status indicator 810 of FIG. 8). After the custom product package is built, it may optionally be validated by testing component 128. While being validated, the system may replace “Building . . . ” status indicator 810 with a “Validating . . . ” status indicator having a corresponding progress bar as an action indicator.

As indicated at block 616, the custom product package is stored in association with a cloud-computing infrastructure (e.g., the cloud computing infrastructure 110 of FIG. 1) such that is accessible via the web portal. For example, after the custom product package is built and optionally validated, it may be automatically or selectably downloaded by the user from an access location identifier, such as a URL. In doing so, the system may replace the currently displayed status indicator with a “Downloading . . . ” status indicator having a corresponding progress bar as an action indicator. As an example, “Download” indicator 714 may initially read “Build” instead of “Download.” Later is may be replaced by text that reads “Download” and corresponds to an access location identifier assigned to the custom product package corresponding to “Creative Cloud Complete” indicator 712. As a further example, “Download” indicator 715 can correspond to an access location identifier assigned to a custom product package that corresponds to “Custom Plan: Design” indicator 711, which was previously built (e.g., similar to the package corresponding to “Creative Cloud Complete” indicator 712, optionally in a different log in session and/or by a different administrator). “Download” indicator 715 is selectable by an administrator for download thereof.

Having briefly described an overview of embodiments of the present invention, an exemplary operating environment in which at least exemplary embodiments may be implemented is described below in order to provide a general context for various aspects of the present invention. Referring to the figures in general and initially to FIG. 9 in particular, an exemplary operating environment for implementing embodiments of the described technology is shown and designated generally as computing device 900. The computing device 900 is but one example of a suitable computing environment and is not intended to suggest any limitation as to the scope of use or functionality of embodiments hereof. Neither should the computing device 900 be interpreted as having any dependency or requirement relating to any one component nor any combination of components illustrated.

The invention may be described in the general context of computer code or machine-useable instructions, including computer-useable or computer-executable instructions such as program modules, being executed by a computer or other machine, such as a personal data assistant or other handheld device. Generally, program modules include routines, programs, objects, components, data structures, and the like, and/or refer to code that performs particular tasks or implements particular abstract data types. The invention may be practiced in a variety of system configurations, including, but not limited to, hand-held devices, consumer electronics, general-purpose computers, more specialty computing devices, and the like. The invention also may be practiced in distributed computing environments where tasks are performed by remote-processing devices that are linked through a communications network.

With continued reference to FIG. 9, the computing device 900 includes a bus 910 that directly or indirectly couples the following devices: a memory 912, one or more processors 914, one or more presentation components 916, one or more input/output (I/O) ports 918, one or more I/O components 920, and an illustrative power supply 922. The bus 910 represents what may be one or more busses (such as an address bus, data bus, or combination thereof). Although the various blocks of FIG. 9 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 9 is merely illustrative of an exemplary computing device that can be used in connection with one or more exemplary embodiments of the present invention. Distinction is not made between such categories as “workstation,” “server,” “laptop,” “hand-held device,” etc., as all are contemplated within the scope of FIG. 9 and reference to “computing device.”

The computing device 900 typically includes a variety of computer-readable media. Computer-readable media may be any available media that is accessible by the computing device 900 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 900. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 912 includes computer-storage media in the form of volatile and/or nonvolatile memory. The memory may be removable, non-removable, or a combination thereof. Exemplary hardware devices include solid-state memory, hard drives, optical-disc drives, and the like. The computing device 900 includes one or more processors that read data from various entities such as the memory 912 or the I/O components 920. The presentation component(s) 916 present data indications to a user or other device. Exemplary presentation components include a display device, speaker, printing component, vibrating component, and the like.

The I/O ports 918 allow the computing device 900 to be logically coupled to other devices including the I/O components 920, some of which may be built in. Illustrative I/O components include a microphone, joystick, game pad, satellite dish, scanner, printer, wireless device, a controller, such as a stylus, a keyboard and a mouse, a natural user interface (NUI), hard/soft button, touch screen display, and the like.

A NUI processes air gestures (i.e., gestures made in the air by one or more parts of a user's body or a device controlled by a user's body), voice, or other physiological inputs generated by a user. These inputs may be interpreted as product package creation requests, generic product package selections, download requests and the like presented by the computing device 900. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 900. The computing device 900 may be equipped with depth cameras, such as, stereoscopic camera systems, infrared camera systems, RGB camera systems, and combinations of these for gesture detection and recognition. Additionally, the computing device 900 may be equipped with accelerometers or gyroscopes that enable detection of motion. The output of the accelerometers or gyroscopes is provided to the display of the computing device 900 to render immersive augmented reality or virtual reality.

As can be understood, aspects of the present invention provide systems, methods, and computer storage media for delivering product packaging as a cloud service to enterprise administrators. Administrators utilize user credentials to log in to a web-based portal where an identifier of each package created by any enterprise administrator of the organization is presented in association with a user interface. Some generic packages pre-created, for instance, by software providers, also may be presented. Utilizing the web-based portal, administrators further may create new product packages or update existing product packages having an identifier presented on the user interface. Product packages that are selected based on their identifiers, created, and/or updated are customized based on the user credentials of the accessing/creating administrator. The user credentials may include, for instance, license information, entitlement information, permissions information, and user preferences (e.g., operating system preferences). Once created, customized packages are stored in association with a cloud computing infrastructure. When an enterprise administrator wants to deploy a customized product package to one or more client machines in their enterprise, the customized product package is downloaded to the administrator's client machine from which it may be deployed. In this way, every package created, updated, or customized by an enterprise administrator is visible to all other administrators in the organization.

Some specific embodiments of the invention have been described, which are intended in all respects to be illustrative rather than restrictive. Alternative embodiments will become apparent to those of ordinary skill in the art to which the present invention pertains without departing from its scope.

Certain illustrated embodiments hereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the methods 200 of FIG. 2 and 600 of FIG. 6 is not meant to limit the scope of the present invention in any way and, in fact, the steps may occur in a variety of different sequences within embodiments hereof. Any and all such variations, and any combination thereof, are contemplated to be within the scope of embodiments of the present invention.

1. A computer-implemented method for creating product packages as a cloud-based service, the method comprising:
receiving, from a web portal, a request from a user to download a generic product package that is pre-created, comprises a plurality of bundled products, and is stored in association with a cloud-computing infrastructure prior to the receiving of the request;
accessing license information of a particular product in the generic product package and required by user credentials associated with the received request;
upon the receiving of the request automatically generating a custom product package from the generic product package to comprise one or more identified products of the plurality of packaged products by removing the particular product from the generic product package based on the accessed license information specifying a license is not available for the particular product; and
storing the generated custom product package in association with the cloud-computing infrastructure such that it is accessible for download by the user to a client device via the web portal.

2. The computer-implemented method of claim 1, further comprising:
assigning an access location identifier to the custom product package; and
presenting the access location identifier on a user interface associated with the web portal.

3. The computer-implemented method of claim 2, wherein the access location identifier comprises a secure Uniform Resource Locator.

4. The computer-implemented method of claim 2, further comprising:
receiving a user selection of the access location identifier; and
initiating the download of the custom product package to the client device associated with the user credentials.

5. The computer-implemented method of claim 2, further comprising presenting a status indicator that indicates a status of the custom product package in association with the user interface of the web portal.

6. The computer-implemented method of claim 5, comprising selecting the status of the custom product package from potential statuses of the custom product package being built, the custom product package being validated, and the custom product package being available for download.

7. The computer-implemented method of claim 1, further comprising validating the custom product package.

8. The computer-implemented method of claim 1, wherein the user credentials further comprise one or more of entitlement information, permissions information, and user preferences.

9. The computer-implemented method of claim 1, wherein the generating the custom product package comprises accessing package detail options selected by an administrator in the web portal in creating the custom product package.

10. The computer-implemented method of claim 1, wherein the generating the custom product package comprises building the custom product package by modifying a generic package.

11. The computer-implemented method of claim 1, wherein the request corresponds to a selection by the user of an identifier of the generic product package, the identifier comprising a name that is descriptive of the plurality of bundled products in the generic product package.

12. The computer-implemented method of claim 1, further comprising tracking at least one of a number of installations of the one or more identified products based on the custom product package and a number of downloads of the custom product package from the web portal, wherein the license is not available for the particular product due to the generic product package not including any more licensed installations.

13. One or more computer storage media storing computer-useable instructions that, when executed by one or more processors, causes the one or more processors to perform a method for providing product packages as a cloud-based service, the method comprising:
presenting, at a user interface associated with a web portal, an identifier of a generic product package, wherein the at least one generic product package is pre-created, comprises a plurality of bundled products and, is stored in association with a cloud-computing infrastructure prior to the presenting;
receiving a selection by a user of the identifier, the user having one or more associated user credentials;
upon the selection of the identifier, automatically generating a custom product package from the generic product package to comprise at least a portion of the plurality of bundled products, at least one product of the portion being tailored in accordance with at least one customization required by the one or more user credentials, wherein automatically generating the custom product package comprises removing at least one of the plurality of bundled products from the generic product package based on the user credentials specifying a license in not available for the at least one product; and
storing the generated custom product package in association with the cloud-computing infrastructure such that it is accessible for download to the user via the web portal.

14. The one or more computer storage media of claim 13, wherein the method further comprises:
receiving a selection by the user of an access location identifier; and
initiating download of the custom product package to a client device associated with the user.

15. A system for creating product packages as a cloud-based service, the system comprising:
a cloud-computing infrastructure having one or more processors and one or more computer-readable storage media; and
at least one data store coupled with the cloud-computing infrastructure,
wherein the cloud-computing infrastructure includes:
a receiving component that receives, from a web portal, a selection by the user of an identifier of a generic product package, wherein the generic product package is pre-created, comprises a plurality of bundled products, and is stored in association with the cloud-computing infrastructure prior to receiving the selection;
a package generating component that collects information for generating a custom product package from the generic product package identified by the selected identifier, the information including user credentials associated with the user, wherein the user credentials comprise at least license information associated with at least one product of the plurality of bundled products;
a package building component that upon the selection of the identifier, automatically generates the custom product package from the generic product package to comprise at least a portion of the plurality of bundled products, the generic product package being tailored in accordance with at least one customization required by the user credentials of the user to result in the custom product package, wherein the at least one product is removed from the generic product package based on the license information specifying a license is not available for the at least one excluded product;
a user interface component that assigns an access location identifier to the custom product package; and
a storing component that stores the custom product package in association with the cloud-computing infrastructure such that it is accessible for download to the user via the web portal.

16. The system of claim 15, further comprising a package testing component that validates the custom product package.

17. The system of claim 15,
wherein the receiving component further receives a selection, by the user via the web portal, of the access location identifier,
and wherein the system further comprises a downloading component that initiates the download of the custom product package to a client device associated with the user.

18. The system of claim 15, wherein the access location identifier comprises a secure Uniform Resource Locator.

19. The system of claim 15, wherein the user credentials further comprise at least one of entitlement information, permissions information, and user preferences.

20. The system of claim 15, wherein the user interface component further presents a status indicator that indicates a status of the custom product package in association with the user interface.
